(19) United States
(12) Patent Application Publication
(10) Pub. No.: US 2014/0096396 A1
(43) Pub. Date: Apr. 10, 2014

(54) RAZOR

(71) Applicant: Jacobus Cornelis PAUW, Cape Town (ZA)

(72) Inventor: Jacobus Cornelis PAUW, Cape Town (ZA)

(21) Appl. No.: 14/032,760

(22) Filed: Sep. 20, 2013

Related U.S. Application Data
(63) Continuation of application No. 12/645,888, filed on Dec. 23, 2009, now abandoned.

(51) Int. Cl. B26B 21/44

(52) U.S. Cl. CPC B26B 21/446
USPC 30/41.5

(57) ABSTRACT

A razor includes a handle, a shaving head which extends from the handle and a blade cartridge which is releasably mounted to the head permitting limited pivotal movement of the blade cartridge. A pressurized canister containing a shaving preparation is located inside the handle. The shaving head defines internal flow passages for conveying shaving preparation from the canister. The razor includes a manually operated delivery mechanism for delivering shaving preparation to the internal flow passages. The blade cartridge comprises a housing having a number of blades mounted therein in an arrangement wherein an internal chamber is defined within the housing at an inner side of the blades. The razor includes two flexible pipes for conveying shaving preparation from the passages to the internal chamber of the blade cartridge where the shaving preparation is pressurized before flowing through spaces between the blades onto a surface to be shaved.

### FIELD OF THE INVENTION

This invention relates to a razor. The invention relates particularly to a razor of the type having a shaving head and a cartridge blade having two or more stacked razor blades, which is movably mounted to the shaving head.

### BACKGROUND OF THE INVENTION

Razors of the abovementioned type are typically used with a suitable shaving preparation such as a foam or gel which is applied to a region to be shaved, ahead of the razor blades. During the use of such razors, shaving debris comprising the shaving preparation, hair, hair follicles, flakes of skin and the like, become wedged between the blades, interfering with the smooth displacement of the blades over the skin. The blade cartridge needs to be cleaned regularly by, for example, dipping the shaving head in water, tapping the shaving head against a rigid object or using the force of water from a tap to dislodge shaving debris from the razor blades.

It has been proposed to provide a razor which includes a dispenser for a shaving preparation and a delivery system for delivering the shaving preparation to an area to be shaved. Prior art documents which disclose a razor having such a dispenser for a shaving preparation include U.S. Pat. No. 5,241,751, U.S. Pat. No. 5,983,500, WO 2005/087040, U.S. Pat. No. 4,077,119, US 2005/0126008, WO 2008/134777 and WO 2008/134776.

The prior art documents mentioned above disclose the delivery of a shaving preparation to the shaving head of a razor. US 2005/0126008 discloses an interior cavity provided in a handle of a shaving apparatus and an actuator including a piston, for causing a shaving preparation to be dispensed adjacent a razor cartridge. U.S. Pat. No. 5,241,751 discloses a wet blade razor including a piston and a one way valve which allows air to be drawn into ducts formed in the piston. The air ducts enable air pressure for forming air bubbles in water in which the razor is immersed, which are forced against the shaving preparation between the blades so as to dislodge the shaving preparation from the blades.

WO 2008/134777 discloses a razor including a container for a shaving preparation and an electrically-powered actuating mechanism for causing the shaving preparation to be discharged from the shaving head.

WO 2008/134776 discloses a razor having a body a shaving head and a blade cartridge which is connected to the shaving head and which includes two spaced razor blades, a source of a shaving preparation and a mechanism for delivering the shaving preparation from the source to the blade cartridge. The blade cartridge is mounted to the shaving head in an arrangement permitting movement of the blade cartridge relative to the shaving head during a shaving operation thereby to permit the blades to follow the contours of a surface being shaved. The shaving preparation is expelled through the blades thereby cleaning the blades in the process. The razor includes a flexible neck which is located upstream of the blade cartridge and which defines an enlarged internal chamber to which the shaving preparation is delivered upstream of the blade cartridge. The neck has an outlet which is connected to the blade cartridge. The blade cartridge has an open rear end defining a rectangular flange with which a surrounding wall of the neck is engaged thereby permitting the shaving preparation to flow from the internal chamber into the blade cartridge and through the space between the blades. The neck is of a flexible material which can bend with a resilient action during movement of the blade cartridge during a shaving operation, although the neck also serves to biase the blade cartridge into a predetermined position relative to the shaving head.

A problem with the neck of the razor described in WO 2008/134776 is that it offers resistance to movement of the blade cartridge relative to the shaving head thereby interfering with the capability of the blades to follow the contours of a surface being shaved. The neck furthermore makes the razor cumbersome and unnecessarily provides an enlarged internal chamber upstream of the blade cartridge, for shaving preparation.

### BRIEF SUMMARY OF THE INVENTION

According to a first aspect of the invention there is provided a razor inducing:
a handle section which is configured to hold a source of a flowable shaving preparation;
a head section extending from the handle section;
a blade cartridge which is releasably mounted to the head section in an arrangement permitting movement of the blade cartridge relative to the head section;
at least one flow passage which leads from the source of the shaving preparation;
a delivery mechanism for delivering shaving preparation from the source along said flow passage, the razor being characterized in that:
   the blade cartridge comprises a housing having an inner side comprising an inner wall defining at least one inlet port for the shaving preparation, an outer side defining a discharge opening for shaving preparation and an internal chamber which extends between said inner and outer sides and within which the shaving preparation is held, the blade cartridge including at least two spaced, parallel razor blades which are mounted to the housing at their respective ends at the outer side of the housing so as to extend across said discharge opening; and
   the razor includes at least one flexible pipe for conveying the shaving preparation, which is connected in a fluid-tight manner at one end thereof to said flow passage and at the opposite end thereof to said inlet port of the housing of the blade cartridge,
   the shaving preparation flowing into said internal chamber within the housing where the shaving preparation is pressurized by the flow of shaving preparation into the chamber, in use, before flowing in an evenly distributed flow through the space defined between the razor blades onto a surface to be shaved.

The pipe may be in the form of a flexible concertina-type pipe which is compressible along the length thereof.

The housing of the blade cartridge may include a pair of spaced opposed mounting formations, the razor blades being fixedly mounted at their respective ends to the blade mounting formations so as to extend under tension between the blade mounting formations.

According to a second aspect of the invention there is provided a blade cartridge for use with a razor including a handle section which is configured to hold a source of a flowable shaving preparation, a head section extending from the handle section, at least one flow passage which leads from the source of the shaving preparation and a delivering mechanism for delivering shaving preparation from the source along the flow passage, the blade cartridge being releasably mountable to the head section of the razor in an arrangement permitting movement of the blade cartridge relative to the head section, the blade cartridge being characterized in that it comprises a housing having an inner side comprising an inner wall defining at least one inlet port for the shaving preparation and an outer side defining a discharge opening for shaving preparation and an internal chamber which extends between said inner and outer sides and within in which the shaving preparation is held, the blade cartridge including at least two spaced, parallel razor blades which are mounted to the housing at their respective ends at the outer side of the housing so as to extend across said discharge opening, the inlet port of the blade cartridge being connectable to a flexible pipe for conveying the shaving preparation, which is connected in a leak-proof manner at one end thereof to said flow passage and at the opposite ends thereof to said inlet port of the housing of the blade cartridge thereby to permit the flow of shaving preparation into said internal chamber within the housing where the shaving preparation is pressurized, in use, before flowing at an evenly distributed flow through the space defined between the razor blades onto surface to be shaved.

The housing may include a pair of spaced opposed mounting formations, the razor being blades being fixedly mounted at their respective ends to the blade mounting formations so as to extend under tension between the blade mounting formations.

### BRIEF DESCRIPTION OF THE DRAWINGS/FIGURES

Further features of the invention are described hereinafter by way of a non-limiting example of the invention, with reference to and as illustrated in the accompanying diagrammatic drawings. In the drawings:

FIG. 1 shows a perspective view of a razor in accordance with the invention;

FIG. 2 shows a side view of the razor of FIG. 1;

FIG. 3 shows a top plan view of the razor of FIG. 1;

FIG. 4 shows a bottom plan view of the razor of FIG. 1;

FIG. 5 shows a partly technical side view of the razor of FIG. 1, showing hidden detail;

FIG. 6 shows an enlarged side view of detail VI of the razor of FIG. 5;

FIG. 7A shows an enlarged side view of detail VII of the razor of FIG. 5 showing the valve stem of the delivery mechanism in a closed position;

FIG. 7B shows an enlarged side view of detail VII of the razor of FIG. 5 showing the valve stem of the delivery mechanism in an open position;

FIG. 8 shows an enlarged fragmentary exploded perspective view of the head section and blade cartridge of the razor of FIG. 1, the delivery mechanism being omitted for the sake of clarity;

FIG. 9 shows a plan view of the outer side of the blade cartridge of the razor of FIG. 1;

FIG. 10 shows a top plan view of the blade cartridge of the razor of FIG. 1;

FIG. 11 shows a plan view of the inner side of the blade cartridge of the razor of FIG. 1.

### DETAILED DESCRIPTION OF THE INVENTION

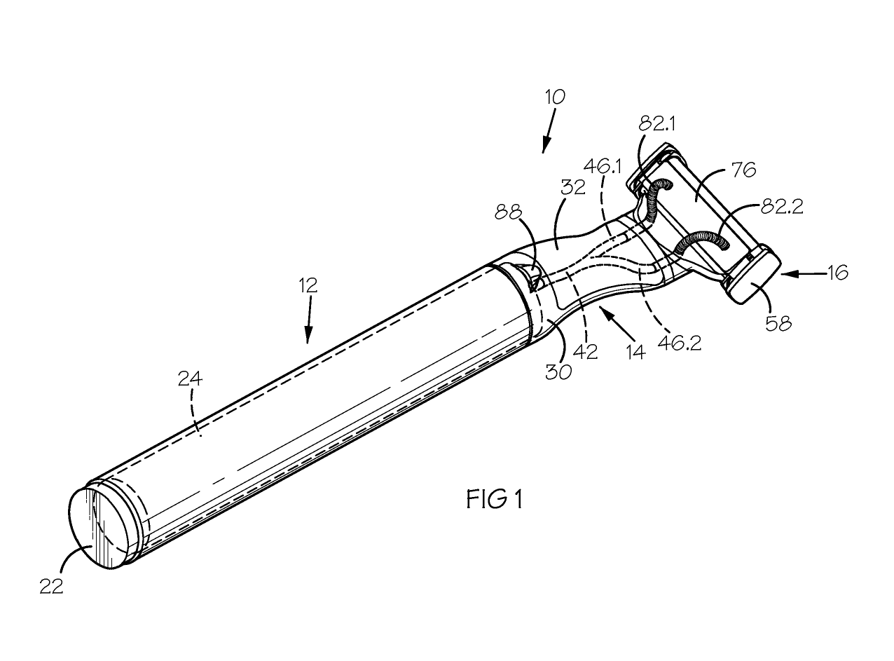

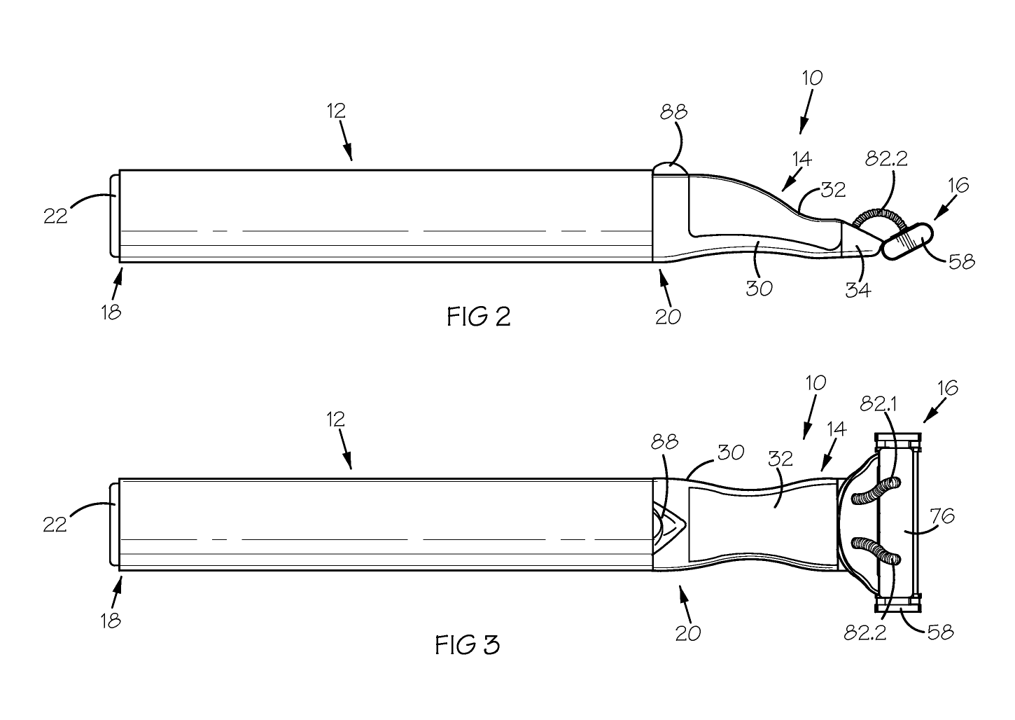

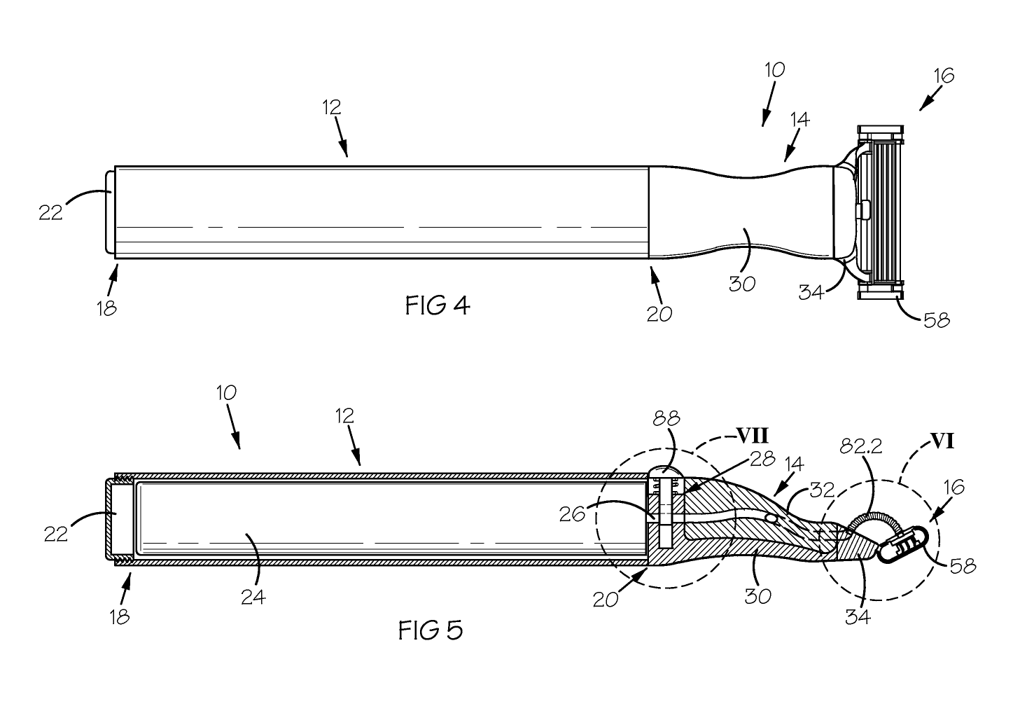

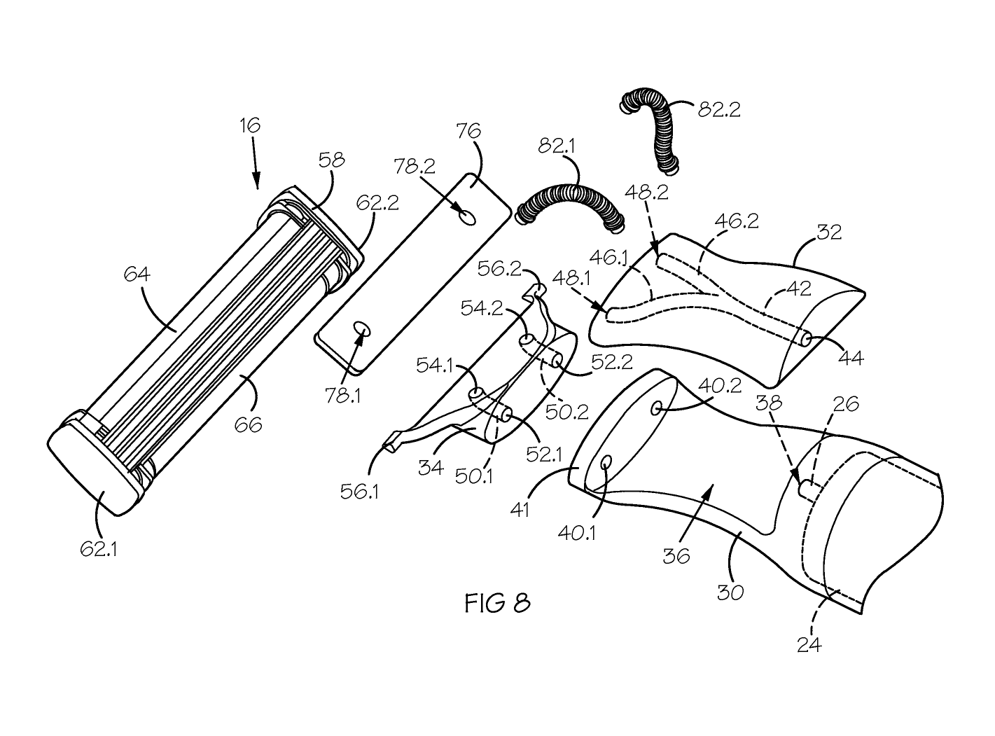

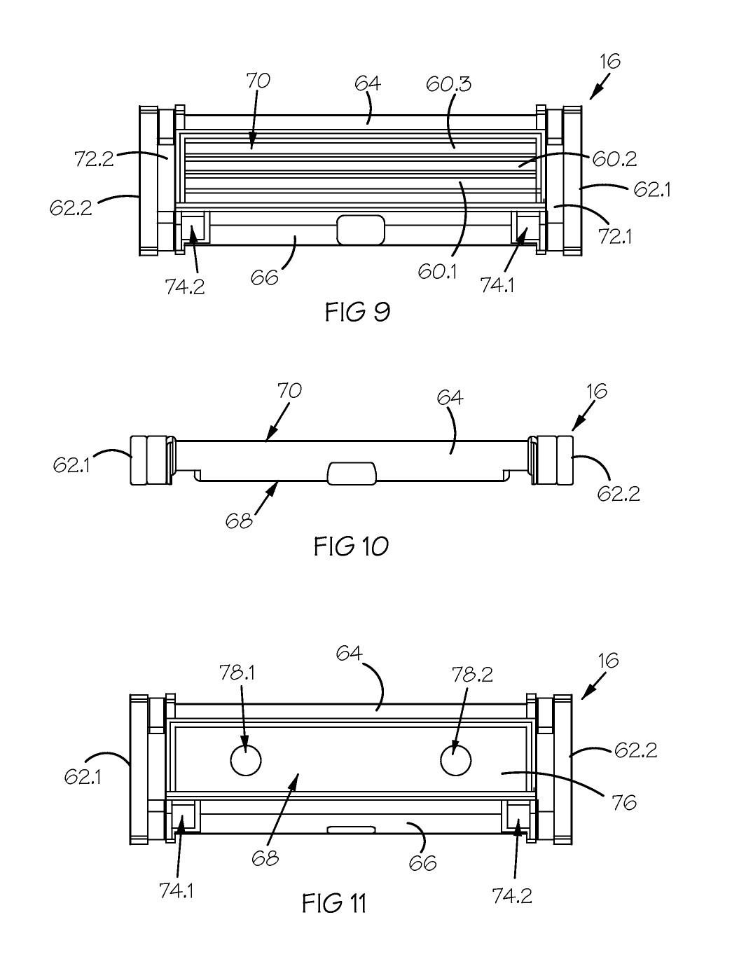

With reference to FIGS. 1 to 11 of the drawings, a razor in accordance with the invention, is designated generally by the reference numeral 10.

The razor 10 comprises, broadly, a handle 12, a shaving head 14 which extends from the handle and a blade cartridge 16 which is releasably mounted to the shaving head in an arrangement permitting limited pivotal movement of the blade cartridge relative to the head.

The handle 12 has an elongate hollow cylindrical configuration and defines a grip by which the razor can be held, on an outer side thereof. The end 18 of the handle 12 is open and internally screw threaded. The razor includes an end cap 22 which is screwed into the open end 18 of the handle 12. A canister 24 containing a shaving preparation is located inside the hollow interior of the handle 12. The canister 24 is internally pressurized and has a discharge nozzle 26 through which the shaving preparation is discharged from the canister. The razor includes a delivery mechanism designated generally by the reference numeral 28, which can be manually operated by a user of the razor and which provides for controlled release of shaving preparation from the canister as will be explained in more detail hereinafter. It will, however, be appreciated that a number of alternative delivery systems providing for the delivery of shaving preparation may be used. One alternative delivery system may include a mechanically or electrically operated delivery mechanism for pressurizing shaving preparation within the canister thereby to provide for controlled release of shaving preparation from the canister. In yet another alternative embodiment, the canister itself may be defined by an internal wall of the handle. The canister may alternatively have a flexible containing wall which can be deformed manually so as to pressurize the shaving preparation contained therein.

The head 14 comprises a body 30 which extends from the end 20 of the handle 12, a cover 32 and a holder 34. The body 30 defines a recess 36 in which the cover 32 is fitted. The body 30 defines an inlet port 38 which is aligned with the discharged nozzle 26 of the canister 24 and two outlet ports 40.1 and 40.2 defined in an oval end wall 41 of the body 30.

The cover 32 defines an internal flow passage 42 having an inlet 44, along which shaving preparation can be conveyed and which branches into two branch passages 46.1 and 46.2 having outlets 48.1 and 48.2, respectively. When the cover 32 is fitted to the body 30, the inlet 44 of the passage 42 is brought into register in a leak-proof manner with the inlet port 38 and the outlets 48.1 are similarly and 48.2 of the branch passages brought into register in a leak-proof manner, with the outlet ports 40.1 and 40.2, respectively, of the body 30.

The holder 34 defines two internal flow passages 50.1 and 50,2 for shaving preparation which defines inlets 52.1 and 52.2 and outlets 54.1 and 54.2, respectively. The holder 34 defines an oval abutment wall 43 which is connected to the oval end wall 41 of the body 30 in an arrangement wherein the inlets 52.1 and 52.2 are brought into register with the outlet ports 40.1 and 40.2 of the body 30, in a leak-proof manner. The holder 34 includes a pair of spaced opposed projections 56.1 and 56.2 which provide for releasable connection of the blade cartridge 16 to the holder 34 as will be explained in more detail hereinafter.

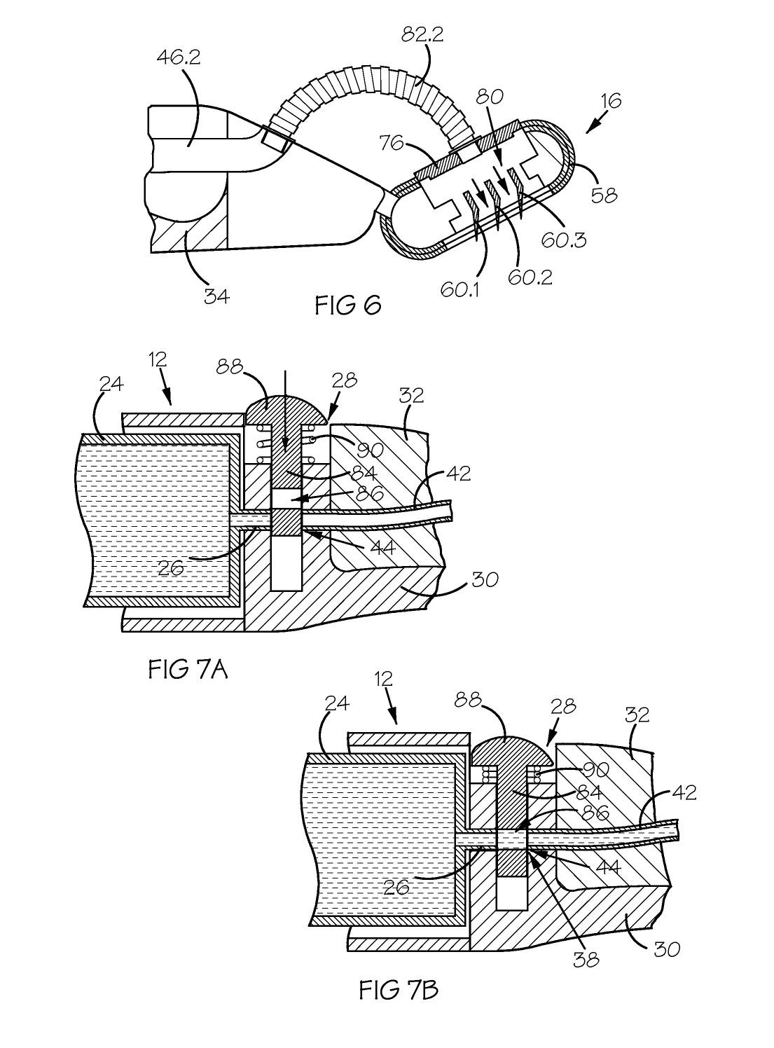

The blade cartridge 16 comprises a housing having three blades 60.1, 60.2 and 60.3 mounted therein. The housing 58 comprises two end plates 62.1 and 62.2, an upper cover 64 which extends between the end plates and a lower cover 66 which is spaced below the upper cover 64 and which also extends between the end plates 62.1 and 62.2. As such, the housing 58 has an inner side 68 and an outer side 70 spaced therefrom. The blades 60.1, 60.2 and 60.3 are mounted within the housing 58 in an arrangement wherein cutting edges of the blades project through the outer side of the housing. More specifically, the blades are mounted to the housing in a spaced parallel arrangement wherein pathways (shown by the arrows in FIG. 6) are defined between the blades through which shaving preparation can flow. The blade cartridge 16 includes plastic moulded blade mounting formations 72.1 and 72.2 which are fixed to the side plates 62.1 and 62.2, respectively, and to which the ends of the blades are fixedly mounted.

The ends of the blades 60.1, 60.2, 60.3 are mounted to the blade mounting formations 72.1 and 72.2 during the moulding of the blade mounting formations, thereby fixing and embedding end regions of the blades within the blade mounting formations. More particularly, the blades are mounted in a tensioned arrangement between the blade mounting formations 72.1 and 72.2. The blades are tensioned between the blade mounting formations during moulding of the blade mounting formations. More specifically, in a first step, first end regions of the blades are in shown by the arrows in FIG. 6) one of the blade mounting formations. After the blade mounting formation has set and cured during moulding thereof, the other blade mounting formation is moulded and during the moulding process, opposite end regions of the blades are embedded in the other blade mounting formation. A tensile force is applied to the blades thereby providing for tensioning of the blades between the blade mounting formations. The advantage of mounting the blades to the housing in this manner is that no spacers, ligatures or other support formations are required in order to support the blades at their ends, thereby providing for a free flow of shaving preparation between the pathways defined by the spaces between the blades. The mounting arrangement therefor obviates the need for support formations between the blades which would therefore have the effect of the blocking the pathways between the blades with shaving debris. This mounting arrangement of the blades thus provides for clear, open pathways for h g preparation between the blades. As such, the shaving preparation has a self-cleaning action as it flows along the pathways between the blades.

In conventional multi-blade cartridges, wherein the blades are fixed at ends thereof in a spaced parallel arrangement, spacers or other support formations are provided which have a resilient construction and which are each fixed at one to an inner side of the blade cartridge so as to extend inwardly into the space defined between two blades. The support formations, being resilient, exert a force on the blades when the blades are deflected from their spaced, parallel arrangement during a shaving operation through contact with the surface being shaved, thereby to return the blades to their parallel arrangement. The support formations thus act as “shock absorbers” by biasing the blades into their spaced, parallel arrangement of the blades while permitting some deflection during a shaving operation.

In order to provide for resilient deflection of the blades 60.1, 60.2 and 60.3, the blades are thus tensioned as is explained hereinabove, between the end mounting formations. The blades are sufficiently thin so as to be resiliently flexible in a direction transverse to the plane of the blades. The flexibility of the blades permits a desirable degree of deflection during a shaving operation. Tensioning of the blades between the end mounting formations has the effect of stiffening the blades thus enhancing the resilience or “springiness” of the blades. This resilience of the blades biases the blades into their spaced, parallel arrangement during a shaving operation. As such, tensioning of the blades allows the blades themselves to act as “shock absorbers”, thereby obviating the need for the resilient support formations described hereinabove, of conventional blade cartridges.

The lower cover plate 66 of the blade cartridge defines recesses 74.1 and 74.2 at an operative inner side thereof, in which the projections 56.1 and 56.2 of the holder 34 are received in an arrangement which provides for limited pivotal displacement of the blade cartridge relative to the holder thereby allowing the cutting edges of the blades to follow the profile of a surface to be shaved. Typically, a biasing mechanism (not shown) will be provided for urging the blade cartridge into a particular orientation relative to the head.

The housing 58 includes an inner plate 76 which is located at the inner side of the housing and which is fitted to the side plates 62.1, 62.2 and the upper and lower plates 64, 66 in a leak-proof manner thereby closing off the inner side of the housing 58. The inner plate 66 defines a pair of inlet ports 78.1 and 78.2 through which shaving preparation can enter the housing 58. The housing defines an internal chamber 80 between the inner plate 76 and inner sides of the blades, which becomes filled with the shaving preparation which is pressurized slightly in the chamber by shaving preparation flowing into the chamber, before flowing in an evenly distributed manner along the pathways defined between the blades and onto a surface to be shaved.

The razor includes two flexible concertina-type pipes 82.1 and 82.2 which are connected in a leak-proof manner between the outlet 54.1 and 54.2 of the holder 34 and the inlet ports 78.1 and 78.2 of the inner plate 76, for conveying shaving preparation to the blade cartridge. The pipes 82.1 and 82.2 being flexible and compressible along the lengths thereof, offer minimal resistance to pivotal displacement of the blade cartridge relative to the holder 34 during a shaving operation.

The delivery mechanism 28 is in the form of release valve mechanism which is mounted to the body 30. The delivery mechanism includes a valve stem 84 which defines an internal passage 86 and which has an actuator button 88 fixed to an upper end thereof. The delivery mechanism includes a coil spring 90 for urging the actuator button 88 and thereby the valve stem into a raised closed position (as shown in FIG. 7A) in which the valve stem blocks the flow of shaving preparation from the nozzle 26 of the canister to the inlet port 38 of the body 30. In use, by depressing the actuator button 88 against the action of the coil spring 90, the valve stem is pushed downwards into an open position (as shown in FIG. 7B) wherein the internal passage 86 of the valve stem 84 is brought into register with the nozzle 26 of the canister and the inlet port 38 in a leak-proof manner wherein the flow of shaving preparation, under pressure, from the canister is permitted into the flow passage 42. The actuator button 88 is operated manually by a user depressing the actuator button thereby providing for a controlled release, under pressure, of shaving preparation to the flow passage 42 thereby facilitating the flow of shaving preparation to the blade cartridge 16. The actuator button includes a releasable locking formation (not shown) which releasably engages a complementary engagement formation of the body 30 for releasably locking the actuator button in a partially depressed position in which the internal passage 86 of the valve stem 84 is brought into partial alignment with the nozzle 26 and the inlet port 38, thereby permitting a reduced flow of shaving preparation to the flow passage 42. In a locked position of the actuator button 88, it will thus not be necessary for the actuator button 88 to be held in a depressed condition. The actuator button 88 can be released from its locking position by merely further depressing the actuator button and releasing it thereby permitting the valve stem to return to its closed position.

In use, the razor in accordance with the invention, provides for the required amount of shaving preparation to be dispensed in a controlled manner directly to an area to be shaved. The delivery of shaving preparation to the blade cartridge has a negligible effect on the normal pivoting action of the blade cartridge relative to the head of razor. More specifically, the flexible concertina pipes 82.1 and 82.2 are particularly effective in delivering shaving preparation to the internal chamber 80 of the blade cartridge while offering minimal resistance to the pivoting action of the blade cartridge.

The invention extends to the blade cartridge. The blade cartridge, being free of any support structures for the razor blades, which may obstruct the free flow of shaving preparation along the pathways through the blades, requires very little cleaning.

What is claimed is:

1. A razor including:
a handle section which is configured to hold a source of a flowable shaving preparation;
a head section extending from the handle section;
a blade cartridge which is releasably mounted to the head section in an arrangement permitting movement of the blade cartridge relative to the head section;
at least one flow passage which leads from the source of the shaving preparation;
a delivery mechanism for delivering shaving preparation from the source along said flow passage, the razor being characterized in that
the blade cartridge comprises a housing having an inner side comprising an inner wall defining at least one inlet port for the shaving preparation, an outer side defining a discharge opening for shaving preparation and an internal chamber which extends between said inner and outer sides and within which the shaving preparation is held, the blade cartridge including at least two spaced, parallel razor blades which are mounted to the housing at their respective ends at the outer side of the housing so as to extend across said discharge opening; and
the razor includes at least one flexible pipe for conveying the shaving preparation, which is connected in a leak-proof manner at one end thereof to said flow passage and at the opposite end thereof to said inlet port of the housing of the blade cartridge,
the shaving preparation flowing into said internal chamber within the housing where the shaving preparation is pressurized by the flow of shaving preparation into the chamber, in use, before flowing in an evenly distributed flow through the space defined between the razor blades onto a surface to be shaved.

2. The razor as claimed in claim 1, wherein the pipe is in the form of a flexible concertina-type pipe which is compressible along the length thereof.

3. The razor as claimed in claim 1, wherein the housing of the blade cartridge includes a pair of spaced opposed mounting formations, the razor blades being fixedly mounted at their respective ends to the blade mounting formations so as to extend under tension between the blade mounting formations.

4. The razor as claimed in claim 2, wherein the housing of the blade cartridge includes a pair of spaced opposed mounting formations, the razor blades being fixedly mounted at their respective ends to the blade mounting formations so as to extend under tension between the blade mounting formations.

5. A blade cartridge for use with a razor including a handle section which is configured to hold a source of a flowable shaving preparation, a head section extending from the handle section, at least one flow passage which leads from the source of the shaving preparation and a delivery mechanism for delivering shaving preparation from the source along the flow passage, the blade cartridge being releasably mountable to the head section of the razor in an arrangement permitting movement of the blade cartridge relative to the head section, the blade cartridge being characterized in that it comprises a housing having an inner side comprising an inner wall defining at least one inlet port for the having preparation and an outer side defining a discharge opening for shaving preparation and an internal chamber which extends between said inner and outer sides and within in which the shaving preparation is held, the blade cartridge including at least two spaced, parallel razor blades which are mounted to the housing at their respective ends at the outer side of the housing so as to extend across said discharge opening, the inlet port of the blade cartridge being connectable to a flexible pipe for conveying the shaving preparation, which is connected in a leak-proof manner at one end thereof to said flow passage and at the opposite ends thereof to said inlet port of the housing of the blade cartridge thereby to permit the flow of shaving preparation into said internal chamber within the housing where the shaving preparation is pressurized, in use, before flowing in an evenly distributed flow through the space defined between the razor blades onto a surface to be shaved.

6. The blade cartridge as claimed in claim 5, wherein the housing includes a pair of spaced opposed mounting formations, the razor blades being fixedly mounted at their respective ends to the blade mounting formations so as to extend under tension between the blade mounting formations.
